(19) United States
(12) Patent Application Publication
(10) Pub. No.: US 2009/0160173 A1
(43) Pub. Date: Jun. 25, 2009

(54) Deformation-free Self-Stick Memo Pad Holder

(76) Inventor: David C.T. JOUR, Taipei (TW)

Correspondence Address: CHINE-HUA CHEN, 13056 TOWN COMMONS DR., GERMANTOWN, MD, 20874, US

(21) Appl. No.: 11/963,879

(22) Filed: Dec. 24, 2007

(51) Int. Cl. B42D 17/00

(52) U.S. Cl. 281/44

(57) ABSTRACT

The invention provides a deformation-free self-stick memo pad holder that mainly comprises an inner case and an outer case; the inner case further is composed of a case cover and a bottom plate. On the case cover surface there are long strips of accommodating space formed by alternate rectangular bump strips and a bottom plate for the embedment of self-stick memo pad stacks. There is also an opening at a proper location of the surface. There is support at the four corners. The outer case can accommodate the insertion of the inner case and there is a groove on its surface corresponding to the opening on case cover surface. After assembly, the invention can facilitate the withdrawal of memo pad. Particularly, the alternate rectangular bump strips on the shell surface of the inner case and the support at the four enable full support and fixation for the outer case, so it prevents deformation or twist by external forces and keeps the inner case immobile.

### BACKGROUND OF THE INVENTION

1. Field of the Invention

The invention relates to the structure for an innovative self-stick memo pad holder. Especially it refers to a deformation-free self-stick memo pad holder that has a structure design by using an inner case and an outer case, and the outer case can be firmly supported by the inner case without the risk of being deformed or twisted by external forces, and can maintain the inner case stationary.

2. Description of the Prior Art

It is common for people to use memo pads in workplace, for emergency contact, messages, reply and reminder et al. Usually memo pads are a stack of a plurality of paper sheets in a certain size. Their back has self-stick adhesive in partial area. The pads are placed into a rectangle fixation base. Thus, the user can peel the paper off, put texts on it, and post it in a place that can be easily noticed. Or the user can stick the paper to the edge of a file folder to note the document category on it. The memo papers provide multiple application functions.

The above disclosed traditional memo pad seems to be suitable for indoor use because the holder has a certain size and does not have much portability. For users who frequently travel outside and need to record messages or notes, they find the limitation for the traditional memo pad which structural design is not satisfactory. Further, a product with simple function and no attractive features tends to be replaced and out of the market in the new era that is driven by innovation. The traditional memo pad (holder)lacks structural diversity and has some drawbacks that have bothered the user for a while. Such product has lost its profitability and competitiveness, and eventually its economic efficiency.

In view of the drawbacks for the traditional memo pad holder, the inventor for the invention has devoted to improvement and innovation, and finally developed an innovative and useful “deformation-free self-stick memo pad holder” that is expected to provide convenience for the users.

### SUMMARY OF THE INVENTION

It is common for people to use memo pads in workplace, for emergency contact, messages, reply and reminder et al. Usually memo pads are a stack of a plurality of paper sheets in a certain size. Their back has self-stick adhesive in partial area. The pads are placed into a rectangle fixation base. Thus, the user can peel the paper off, put texts on it, and post it in a place that can be easily noticed. Or the user can stick the paper to the edge of a file folder to note the document category on it. The memo pads provide multiple application functions.

The above disclosed traditional memo pad seems to be suitable for indoor use because the holder has a certain size and does not have much portability. For users who frequently travel outside and need to record messages or notes, they find the limitation for the traditional memo pad which structural design is not satisfactory. Further, a product with simple function and no attractive features tends to be replaced and out of the market in the new era that is driven by innovation. The traditional memo pad(holder)lacks structural diversity and has some drawbacks that have bothered the user for a while. Such product has lost its profitability and competitiveness, and eventually its economic efficiency.

In view of the drawbacks for the traditional memo pad holder, the inventor for the invention has devoted to improvement and innovation, and finally developed an innovative and useful “deformation-free self-stick memo pad holder” that is expected to provide convenience for the users.

### BRIEF DESCRIPTION OF THE DRAWINGS

FIG. 1 is a disassembly diagram for the self-stick memo pad holder for the invention.

FIG. 2 is an exterior diagram for the inner case of a preferred embodiment for the invention.

FIG. 3 is a structural diagram for the self-stick memo pad of a preferred embodiment for the invention.

FIG. 4 is an exterior diagram for memo pad holder of a preferred embodiment for the invention.

FIG. 5 is a sectional view for the memo pad holder of a preferred embodiment for the invention.

### DETAILED DESCRIPTION OF THE PREFERRED EMBODIMENT

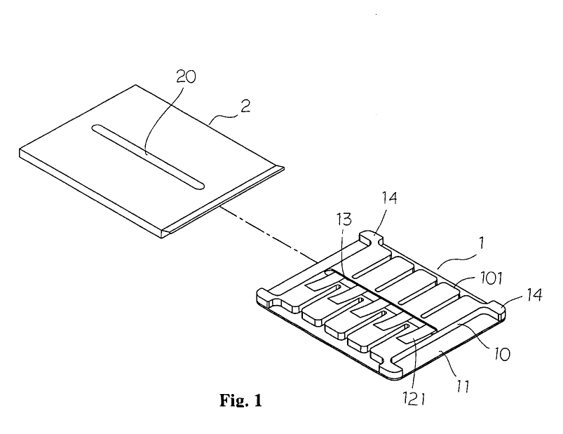

Please refer to FIG. 1 for the invention that is a deformation-free self-stick memo pad holder that comprises:

An inner case (1), comprising a case cover (10) and a bottom plate (11), which case cover (10) surface there are alternate rectangular bump strips (101) that work with a bottom plate (11) to form several long strips as accommodating space, inside which there are self-stick memo pad stacks (12), and which at a proper location on the case cover (10) surface there is an opening (13) across the entire rectangular bump strips (101), and especially at the four corners of the case cover (10) there forms support (14) with integrated structure; and

An outer case (2), appearing flat and accommodating the insertion of the inner case (1), on which surface there is a groove (20) corresponding to the opening (13) on the case cover (10) surface.

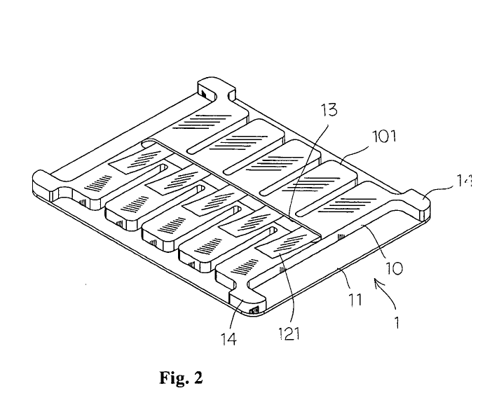

Please refer to FIG. 2 that the inner case (1) has several long strips of accommodating space formed by the rectangular bump strips (101) alternately on the case surface and the bottom plate (11) for the embedment of the self-stick memo pad stacks (12), and the uppermost piece of the self-stick memo paper (121) in the stack sticks out of the opening (13) to facilitate the withdrawal, which benefits are not only simplicity and convenience but also prevention of withdrawal of multiple pieces of self-stick memo papers (121).

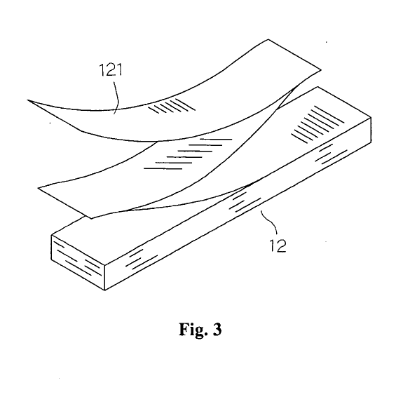

Please refer to FIG. 3 that the self-stick memo pad stack (12) is composed of many pieces of self-stick memo papers (121). Half of each self-stick memo paper (121) has adhesive to stick to another self-stick memo paper (121). Besides the location of adhesive on the neighboring self-stick memo papers (121) is alternate; and the self-stick memo pad stack (12) can be in different color for easy classification.

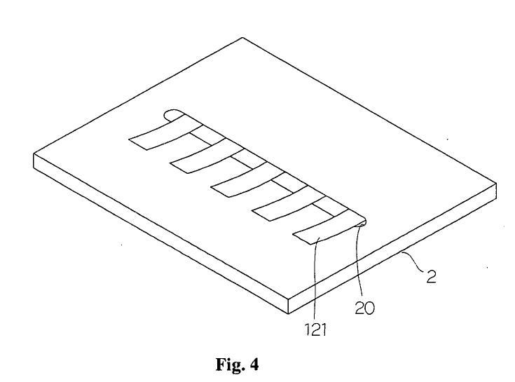

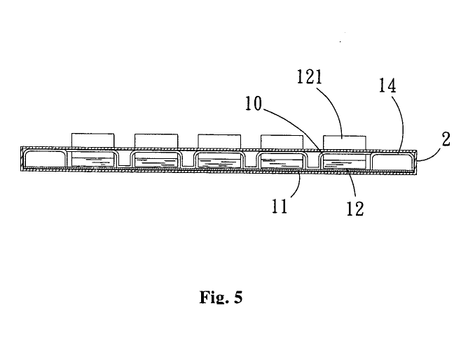

Please refer to FIG. 4 that the structure for the above mentioned self-stick memo pad holder can facilitate the assembly process, which is completed by putting the inner case (1) inside the outer case (2) to form an integrated combination, and then passing all the self-stick memo papers (121) that stick out of the opening (13) of the case cover (10) surface through the groove (20) on the outer case (2) surface. Since the self-stick memo pad holder is lightweight and very thin and the self-stick memo pad stacks are in a good quantity, the invention is particularly suitable for use as a portable object. Most importantly, as shown in FIG. 5, on the shell (10) surface for the inner case (1) there are many alternate rectangular bump strips (101) and at four corners there is support (14) to firmly uphold the outer case (2). In one aspect, this will prevent the outer case (2) from deformation or twist by external forces. In another aspect, this will keep the inner case (1) immobile without affecting the withdrawal of the self-stick memo paper (121). Moreover, all the self-stick memo pad stacks (12) can be in different colors, red, orange, yellow, green or blue et al., to facilitate the identification and classification of documents by the users and achieve multiple benefits of use.

In summary, the invention is an excellent product that has never been developed or published in similar product category. It shall meet the requirements for patent application. Thus, the application is submitted. However, the above-mentioned embodiment is only the preferred embodiment for the invention. Those equivalent modification or alteration based on the description and figures for the invention shall also be covered by the scope of the invention.

What is claimed is:

1. A deformation-free self-stick memo pad holder comprises:
an inner case, including a case cover and a bottom plate, on which said case cover surface includes at least one strip of accommodating space formed between the alternate rectangular bump strips and bottom plate for accommodating memo pad stacks; at a predetermine location on which said case cover surface there is an opening across the rectangular bump strips and around the four corners of the case cover to form support means;
an outer case, accommodating the insertion of the inner case, on which surface there is a groove corresponding to the opening on the case cover surface.

2. As described in claim 1 for a deformation-free memo pad holder, the self-stick memo pad stack is made of many pieces of self-stick memo papers; half the bottom of each self-stick memo paper has adhesive to stick to another self-stick memo paper, the location of adhesive for the neighboring self-stick memo paper is alternated between self-stick memo paper.

3. As described in claim 1 for a deformation-free memo pad holder, the self-stick memo pad stacks are made into different colors.
